(19) United States
(12) Patent Application Publication
(10) Pub. No.: US 2026/0350799 A1
(43) Pub. Date: Nov. 5, 2026

(54) COMPUTER-IMPLEMENTED METHOD FOR EVALUATING A LATERAL FLOW TEST

(71) Applicant: Roche Diabetes Care GmbH, Mannheim (DE)

(72) Inventors: Max Berg, Mannheim (DE); Fredrik Hailer, Limburgerhof (DE); Bernhard Limburg, Soergenloch (DE); Volker Tuerck, Berlin (DE); Susana Contreras, Berlin (DE)

(21) Appl. No.: 19/710,557

(22) Filed: Jun. 17, 2026

Related U.S. Application Data
(63) Continuation of application No. PCT/EP2024/086653, filed on Dec. 16, 2024.

(30) Foreign Application Priority Data
Dec. 19, 2023 (EP) 23 217 821.0

(51) Int. Cl. G06T 7/00; G06T 5/20; G06T 5/70; G06T 7/13; G06T 7/60; G06T 7/73

(52) U.S. Cl. CPC G06T 7/0012; G06T 5/20; G06T 5/70; G06T 7/13; G06T 7/60; G06T 7/73; G06T 2207/30004

(57) ABSTRACT

A method for evaluating a lateral flow test with regard to the presence or absence of a test line and a control line within a test area of the lateral flow test that includes: receiving image data of the test area generated with a camera comprised by a mobile device, determining at least a direction and a width of a control line within the test area of the image data, generating a direction selective filter based on the direction and width of the control line, wherein the direction selective filter is a digital filter to enhance and/or suppress features in an image data depending on the orientation, filtering the image data with the direction selective filter, evaluating the filtered image data with regard to a presence or an absence of a test line, and providing a result of the lateral flow test.

### RELATED APPLICATIONS

This application is a continuation of PCT/EP2024/086653, filed Dec. 16, 2024, which claims priority to European Patent Application No. 23 217 821.0, filed Dec. 19, 2023, the entire disclosures of both of which are hereby incorporated herein by reference.

### BACKGROUND

This disclosure relates to a computer-implemented method, a computer program, a non-transitory computer-readable storage medium, including instructions, and a computing device for evaluating a lateral flow test based on an image data of a test area of a lateral flow test, wherein the image data is generated with a camera comprised by a mobile device.

In the field of medical diagnostics, in many cases, one or more analytes have to be detected in samples of a body fluid, such as blood, interstitial fluid, urine, saliva, nasal swab or other types of body fluids. Examples for analytes to be detected are biomarkers, pathogens, mycotoxins, cells nucleic acids, e.g., glucose, triglycerides, lactate, cholesterol or viruses.

One type of such tests commonly used in medical, consumer, food, agriculture, environmental and veterinary testing are so-called lateral flow based tests that detect the presence or absence of the target analyte in a sample. Such tests are widely used for medical diagnostics for either home testing, point of care testing, laboratory or hospital use. A well-known application is the home pregnancy test or testing for the SARS-COV-2 coronavirus.

An example of a lateral flow test detecting viral nucleic acids is disclosed in WO 2021/228839 and in references cited therein, which are also referred to as “SHERLOCK” tests. Further, instead of blood tests, saliva was proposed as a suitable sample material for SARS-COV-2 detection (Wyllie et al. (2020), medRxiv 2020.04.16.20067835; doi.org/10.1101/2020.04.16. 20067835). B. Ince and M. K. Sezgintürk provide in “Lateral flow assays for viruses diagnosis: Up-to-date technology and future prospects,” 2022, TrAC Trends in Analytical Chemistry, Volume 157, 116725, an overview of current problems and accessible solutions in detecting infectious agents and diseases by lateral flow assay (LFA), focusing on increasing sensitivity with various detection methods. Further, the sensitivity of SARS-COV-2 antigen rapid diagnostic tests (Ag RDT) was evaluated in “Comparative sensitivity evaluation for 122 CE-marked rapid diagnostic tests for SARS-COV-2 antigen, Germany, September 2020 to April 2021,” H. Scheiblauer et al., Eurosurveillance, 26, 2100441 (2021).

Typically, the detection of the analyte may rely on an optical detection reaction that becomes visible on an optical test element to indicate the presence of the analyte. When using a mobile device for detecting the analyte, particularly in home-testing scenarios, images of the optical test element may be captured by a camera comprised by the mobile device. The detection of the analyte may then be based on a computer-implemented analysis of the images. The detection of the visible optical detection reaction may be performed considering the full image or at least one defined region of interest on the image.

Examples of an image-based test strip identification method are disclosed in U.S. Publication No. 2022/0392071 A1 and GB 2601978 A. To increase the reliability of an image-based evaluation CN 216956993 U discloses an additional background device with a plurality of line detection fiducials. Another approach to reliably read a lateral flow test is a read out apparatus as disclosed in U.S. Publication No. 2016/0054316 A1.

A technical challenge may lie in the circumstance that these images may contain artifacts, such as unwanted distortions or anomalies that may occur during the image acquisition and/or processing, which are difficult to distinguish from the visible optical detection reaction. Furthermore, typically the position and orientation of the lateral flow test, and in particular the visible test signals, are unknown, if the image is taken with a mobile device.

In case the optical detection reaction represents a line feature, a line detection algorithm may exemplarily be used and a line on the image may be considered as visible optical detection reaction. There may be cases, in which the line detection algorithm cannot clearly determine whether there is a line that is associated with an optical detection reaction or an artifact. This may lead to false positive detections of the analyte, particularly in case an artifact may be classified and/or identified as a visible optical detection reaction. Also features in the image, such as shadows or the like, may lead to false positive detections by image recognition algorithms.

U.S. Pat. No. 11,275,020 B2 discloses an automated method of determining a lateral flow assay device including several markers, a color bar, and/or a grayscale on the housing of the lateral flow assay device. The markers are used to assist in focusing a mobile device's camera on the control line of the lateral flow assay device. The markers may be used to adjust the perspective of an image taken from the control line and the test line of the lateral flow assay device. The markers may be used to locate the images of the control line, the test line, the color bar, and/or the grayscale on the image. The image of the color bar and the grayscale may be used to adjust the colors and intensity of the image. The images of the test line and the control line may then be used to determine the test results of the lateral flow assay device.

To enhance the quality of an automated evaluation of a lateral flow assay U.S. Pat. No. 11,412,931 B2 discloses an image processing technique wherein the method uses a curve field transformation to filter out artifacts and extract relevant features from the image before determining a test result based on the transformed image.

Another method to emphasize a contrast of a test signal in an image of a lateral flow assay is disclosed in U.S. Publication No. 2022/0003761 A1 where a system is described that comprises a color filter that may be positioned over a lens of a camera of a mobile device to emphasize a contrast of a test signal.

U.S. Publication No. 2021/0263018 A1 discloses an image correction algorithm used to maximize the signal to noise ratio of an image of a lateral flow test. The algorithm uses matched filters, wherein the parameters of the matched filters, such as its width and shape, are determined using a statistical model derived from empirical measurements obtained from a large number of test results performed from different known concentrations, or a machine learning algorithm trained from said data.

To prevent false positive results caused by artifacts or falsely identified features in an image of the lateral flow test, typically the detection threshold is increased, therewith decreasing the sensitivity on the detection of the analyte.

### SUMMARY

It is therefore desirable to provide a method for automated evaluation of a lateral flow test based on images taken with a mobile device that at least partially address the above-mentioned challenges. In particular, it is desirable to provide an automated evaluation method that neither requires a specific reading device nor places increased demands on the user. Furthermore, it is specifically desirable to provide a method with a decreased rate of false positive detection without sacrificing the sensitivity of the detection.

The term “computer-implemented” refers to a method that is performed by using computer programming, and/or by using at least one computer and/or at least one computer network. Thus, as an example, one or more or even all of the method steps may be performed by appropriate software, e.g., by using computer-readable instructions, which, when executed on a computer or a computer network, cause the computer or computer network to perform the method steps.

A “lateral flow test,” also called lateral flow device, lateral flow immunochromatographic assay, or rapid test, refers to a device intended to detect the presence of a target substance in a liquid sample on the bases of affinity chromatography. Exemplary lateral flow assays are pregnancy rapid tests or covid rapid tests.

Lateral flow tests operate on the principles of affinity chromatography for isolation of a specific analyte, the target substance, in a liquid sample, e.g., a sample of a bodily fluid, via a highly specific macromolecular binding interaction between the target substance and another substance. The specific type of binding interaction depends on the target substance, e.g., antigen and antibody, enzyme and substrate, receptor and ligand, or protein and nucleic acid.

Lateral flow tests comprise a series of capillary beds, such as pieces of porous paper, micro-structured polymers or the like. Typically, a sample pad soaks up the sample fluid to transport it to the following pads, in particular pads containing all required reagents, at least one test line, and a control line. While the test line shows a signal only if the target substance is present, the control line shows a signal in the case a sample has flowed through and the required reagents are active. The signal of the test line as well as the control line often are a color such as in pregnancy tests, or covid tests, i.e., rely on a color formation reaction resulting in an optically detectable signal. The term “control line” refers to a zone of the lateral flow test showing the control signal that typically has a line shape. Correspondingly, the term “test line” refers to a typically line shaped zone of the lateral flow test showing a test signal if a specific target substance is present in the applied sample. As a single test line is sensitive to a specific target substance or analyte the lateral flow test has to comprise at least one test line for each analyte to be detected. The test line or test line signal typically has an identical or very similar geometric structure as the control line, but its brightness and color typically depends on the amount of the target substance, e.g., on a viral load.

The term “analyte” refers to a substance or chemical constituent that is of interest in an analytical procedure and is also referred to as component or chemical species or target substance. Examples for analytes to be detected are biomarkers, pathogens, mycotoxins, cells nucleic acids, e.g., glucose, triglycerides, lactate, cholesterol or viruses. The analyte is comprised in at least one sample of a bodily fluid, such as blood, interstitial fluid, urine, saliva, nasal swab or other types of body fluids of a subject, that is applied to a receiving area of the lateral flow test.

The term “image data,” also called digital image data, digital image, or image, refers to a collection of information representing visual content in a digital format. Typically, an image data or image may comprise one or more pixels, e.g., a two dimensional array of pixels. The one or more pixels may be arranged in a known manner, particularly a known grid. Any one of the one or more pixels may comprise at least one numerical value defining a color and/or an intensity of the respective pixel. The numerical value may be binary data and/or data of a known color model, also called color space, such as RGB (Red, Green, Blue) or CMYK (Cyan, Magenta, Yellow, Black). Alternatively or in addition, the image data may be vector image data. The vector image data may be at least one of: one or more points, one or more lines, one or more curves, and one or more further geometric elements.

The term “camera” refers to an optical instrument used to capture and store images and/or videos. Here the term “camera” is particularly used for a device to capture digital images, i.e., image data via an electronic image sensor.

The term “mobile device” refers to a mobile electronics device, specifically a personal mobile device (PDA), more specifically, to a mobile communication device such as a cell phone and/or a smartphone. Additionally or alternatively, the mobile device may also refer to a notebook, a tablet computer or another type of portable computer, such as a wearable, specifically smart glasses, having at least one camera. Alternatively or in addition, a smartphone having an external camera may be used. The external camera may be comprised by spectacles. The mobile device may comprise one or more processors, e.g., for performing the computer-implemented method.

The term “dynamic filtering” here refers to a digital filter, i.e., system that performs mathematical operations on the image data to reduce or enhance certain aspects of the data structure, wherein at least one parameter of the mathematical operations is determined and/or adapted based on information gathered from the same image data.

The term “digital filter” generally refers to a system that performs mathematical operations on a sampled, discrete-time signal to reduce or enhance certain aspects of that signal. This is in contrast to the other major type of electronic filter, the analog filter, which is typically an electronic circuit operating on continuous-time analog signals. In the following the term “filter” refers to a “digital filter” if not indicated otherwise.

The inventive method enables a very reliable automated evaluation of a lateral flow test using a mobile device for image data generation. The method makes it possible to reduce the requirements on the user and to increase sensitivity at the same time.

In a first aspect, a computer-implemented method for evaluating a lateral flow test with regard to a presence or absence of at least one test line, additionally to a control line, within the test area of the lateral flow test, i.e., a method that includes the following computer executable steps:
a. receiving an image data of the test area of a lateral flow test, wherein the image data is generated with a camera comprised by a mobile device,
b. determining at least a direction and a width of a control line within the test area of the image data of the previous step,
c. generate a direction selective filter based on the direction and width of the control line determined in the previous step,
d. filter the image data of step a with the generated direction selective filter,
e. evaluate the filtered image data of the previous step with regard to presence or absence of a test line, and
f. providing a result of the lateral flow test based on the evaluation of the previous step.

In step a, the image data of a test area of the lateral flow test is received, wherein the term “test area” refers to at least the part of a lateral flow test comprising the test line as well as the control line. The lateral flow test may be a plain test strip or a kit comprising a housed test strip with a window comprising at least the test area to plain view, or any other type of device comprising the test area. The image data may be generated by any mobile device, i.e., any hand-held camera, so that the alignment of the lateral flow test and/or the position of the test area within the image data may be unknown. Furthermore, due to the broad variety of mobile device hardware and image/signal processing steps of mobile devices the representation of the lateral flow test, specifically of the color and/or contrast of the control line and, if present, the test line, may vary. Moreover, inhomogeneity in the illumination of the test field or shadows on the test field may result in structures in the image data that may falsely be identified as a line, e.g., as a test line.

In an embodiment, in a further step a.1, the image data received in step a is converted to a predetermined color space. The term “color space” generally refers to a specific organization of colors or, in other words, the set of colors or grey values that can be used by a color processing method, including color capture, further processing and color reproduction. Examples for different color spaces are the CMYK color model, the RGB color model, L*a*b*, achromatic colors, grey scales, intensities, or a single color channel. The term “L*a*b* color space,” also called CIELAB color space, is a color space defined by the International Commission on Illumination and expresses color as three values: L* for perceptual lightness and a* and b* for the four unique colors of human vision: red, green blue and yellow. “Predetermined color space” refers to a specific color space chosen depending type of signal, e.g., color, of the lateral flow test. The predetermined color space is a color space that is suitable to depict the signals of the lateral flow test, i.e., the signal of the control line and the test line, in particular a color space that enhances the contrast of the test and control line compared to the color space of the received image data. For example, if the signal of the lateral flow test is red, i.e., the control line and, if there, the test line, are red lines on a white background, i.e., an otherwise white lateral flow test, a predetermined color space may be the green-channel and/or blue-channel of an originally RGB image data, as a red line will appear darker, i.e., showing more contrast, in the image data of those channels. The predetermined color space for an image of said red line(s) may alternatively be a grey scale, an intensity distribution or the L*a*b* color space, or any other known color space capable of reproducing the signal of the control line and the test line.

The term “color space conversion” refers to the translation of the representation of a color from one basis to another. This typically occurs in the context of converting an image data that is represented in one color space to another color space. The transition or projection into another color space may help to enhance contrasts in the image which may help for feature recognition. A color space conversion may, for example, convert image data from the RGB color space into grey scale image data or into the L*a*b* color space or into the L* channel of the L*a*b* color space.

In an alternative or additional embodiment, the method may include a further step a.2 of smoothing the image data is by using a filter. The term “smoothing” a data set such as digital image data refers to creating an approximating function that captures important patterns in the image data while leaving out noise or other fine-scale structures or rapid phenomena or artifacts. Many different algorithms, in particular many different linear smoothers, that is linear algorithms for smoothing image data are known such as, for example, mean filters, or Gaussian filters. This filter may, for example, be a Savitzky-Golay filter, or a low pass filter, or any other known smoothing filter. This further step may, for example, be performed as a pre-processing step after step b and before step c. Alternatively, this step may be performed after step a and before step b. Another alternative filter for smoothing the image data is a so-called median filter.

In a further embodiment, the method may include a further step of selecting a section of the image data, in particular, of determining a position of the test area in the image data and reducing the image data to only comprise the determined test area. The further step may, for example, be performed as a pre-processing step after step a or after step a.1 or after step a.2.

Any pre-processing steps such as a.1 or a.2 or selecting a section of the image may be performed as part of step a.

In step b, the image data received in step a or the converted image data from step a.1 or a.2 or any other pre-processing step is used to determine at least a direction and a width of a control line within the test area. Here, the terms “direction” and “width” are to be given its ordinary and customary meaning to a person of ordinary skill in the art. In particular, the term “direction” is used for the orientation of the control line within the image, e.g., the orientation/direction of a longitudinal axis of the line, while the term “width” is used for the line thickness, e.g., a dimension or spread of the line in a direction perpendicular to its longitudinal axis. The determining of the direction and the width may be done by any filter, function, kernel, etc. known to a person skilled in the art to extract at least said information from digital data such as the image data, the determining may further comprise at first determining an area or position of the control line. It is understood that if the test area of the lateral flow test does not show control line the lateral flow test is not functioning, thus there is no result to be determined but a failure of the test. On the other hand, a functioning lateral flow test always shows a strong control line that according to this disclosure is used to determine at least two of its characteristics namely its width and its orientation which also correspond to characteristics of the test line.

In an embodiment, step b comprises using an edge detection function, which is a well-known example to identify a feature such as the control line within image data and to enable determination of control line features such as direction and width. The term “edge detection function” refers to any mathematical method that aims at identifying edges, defined as curves in a digital image data at which the image data brightness changes significantly. There are many well-known methods for edge detection functions, but most of them can be grouped into two categories, search-based and zero-crossing based. The search-based methods, e.g., the Canny edge detector, detect edges by first computing a measure of edge strength, usually a first-order derivative expression such as the gradient magnitude, and then searching for local directional maxima of the gradient magnitude using a computed estimate of the local orientation of the edge, usually the gradient direction. While some of the edge detection functions work best with sharp edges, i.e., sharply changing brightness or even a brightness showing a discontinuity other edge detection function also work with smoother brightness changes, i.e., smoother edges.

The control line of a functioning lateral flow test typically does not show particularly sharp edges. Still, as the control line in a functioning lateral flow test typically is a strong and pronounced structure with a good contrast, the requirements for the sensitivity of the function used to determine the width and direction of the control line are not very high, in particular, compared to the sensitivity necessary for detecting the signal of the test line, if present, as the test line sometimes may show only a weak or very weak contrast.

In an alternative or additional embodiment, step b comprises calculating a magnitude and orientation of an image data gradient for each pixel of the image data, and determining clusters of pixels with similar orientation. Thus, according to this embodiment the edge detection function used in step b relies on the computation of the image gradients, wherein “image data gradient” refers to a directional change in the intensity or color in an image data. The gradient of the image data is one of the fundamental building blocks in image data processing. The gradient orientation, i.e., a gradient vector, may be calculated at each pixel by convolving the image data with horizontal and vertical derivative filters. A cluster of pixels with a similar orientation of the gradient may be an indication of a line shaped feature within the image data. If the gradient magnitude, i.e., the steepness of a slope at each pixel, exceeds a threshold, this may be an indication of an edge point within the image data.

In another alternative or additional embodiment, step b comprises identifying the control line within a predefined section of the image data. The predefined section may be the test area, or a portion of the test area, e.g., a first portion of the test area, where the control line area is located. This may increase reliability of the method and/or accelerate step b. The predefined section may be identified via indicator structures or the like oftentimes comprised by lateral flow test.

In step b, an inherent characteristic of a lateral flow test, namely the pronounced recognizability of the control line, is used to determine certain characteristics of the test line such as, for example, its orientation, or its width, that the control line shares with the test line.

In step c, the information determined in step b, i.e., the direction and width of the control line, is used as a bases for generating a direction selective filter. The term “direction selective filter” refers to a digital filter used in image processing to enhance and/or suppress features in an image data depending on the orientation, i.e., direction within the image data. In particular, a direction selective filter may be an anisotropic filter that enhances all features/curves within the image following a predefined direction and suppresses all features extending in directions differing from the predefined direction. Using the determined characteristics of the control line which correspond to characteristics of the test line, as a bases for the direction selective filter, adapts the filter specifically to the determining of the test line and increases the sensitivity of the evaluation step.

In an embodiment, the direction selective filter is a Gabor kernel function. The term “Gabor kernel function,” also called Gabor filter or Gabor kernel, refers to a linear band pass filter used in image processing for texture analysis. The Gabor kernel function may analyze if there is any specific frequency content in a specific direction within an image or image data. The image response of a Gabor kernel function is created by multiplying a Gaussian envelope function with a complex oscillation. Correspondingly the real component of the impulse response of a Gabor kernel function is

$$g ( x , y ; λ , θ , ψ , σ , γ ) = exp ( - \frac{{x}^{′ 2} + {γ}^{2} {y}^{′ 2}}{2 {σ}^{2}} ) cos ( 2 π \frac{{x}^{′}}{λ} + ψ )$$

and the imaginary component is

$$g ( x , y ; λ , θ , ψ , σ , γ ) = exp ( - \frac{{x}^{′ 2} + {γ}^{2} {y}^{′ 2}}{2 {σ}^{2}} ) sin ( 2 π \frac{{x}^{′}}{λ} + ψ )$$

with

x′=x cos θ+y sin θ and y′=−x sin θ+y cos θ.

θ represents the orientation of the normal to the parallel stripes of the Gabor function controlling the orientation of the Gabor kernel function. λ represents the wavelength of the sinusoidal component governing the width of the strips of the Gabor function. ψ represents the phase offset of the sinusoidal function. σ represents the standard deviation of the Gaussian envelope and controls the overall size of the Gabor envelope. γ represents the spatial aspect ratio and specifies the ellipticity of the support of the Gabor kernel function controlling the height of the Gabor kernel function.

By relying on the direction and width of the control line, i.e., tuning the direction selective filter, for example, λ and θ of the Gabor kernel function, based on the characteristics of the control line, the direction selective filter such as the Gabor kernel function becomes specifically sensitive to features having said same or similar characteristics. As the direction selective filter, e.g., the Gabor kernel function, is adapted/tuned on the bases of information gained from the image data itself, the generated direction selective filter or Gabor kernel function may be referred to as a dynamic filter.

In step d, the generated direction selective filter, e.g., the generated Gabor kernel function, is applied to the image data, preferably the image data received in step a, or the converted image data of step a.1, i.e., the image data converted into a predetermined color space, or the smoothed image data of a further smoothing step a.2. The direction selective filter enhances any structure corresponding to the control line at least in width and direction, i.e., the test line if present, and suppresses any structures that do not share at least these characteristics.

In step e, the filtered image, or at least a part of the filtered image data, for example, the imaginary impulse response of the Gabor kernel function, is evaluated to determine whether the lateral flow test is positive or not, i.e., whether it contains/shows any further structure with the characteristics of the control line, that is, whether a test line has formed/shows a signal.

In an embodiment, step e comprises determining if the filtered image data in a direction perpendicular to the direction of the control line comprises only one typical line-induced structure or at least two line-induced structures. The term line-induced structure refers to a structure or feature in the filtered image data resulting from the presence of a line in the underlying image data. A line-induced structure is, for example, a maximum, or a minimum, or a pair of a minimum and a maximum in a certain distance characteristic of the line width. For example, this may be determined by asserting whether an intensity curve perpendicular to the direction of the control line shows a single line-induced structure, such as, for example, a minimum-maximum sequence corresponding to the control line, or if the intensity curve shows two or more line-induced structures, indicative of a second or even further lines, i.e., one or more test lines.

In a further embodiment, step e may comprise limiting the testing for a test line signal/structure to a section of the image data, e.g., the test area, a half or other fraction of the test area or any other section of the image data that contains the test line area. For example, step e may comprise determining if the filtered image data in a direction perpendicular to the direction of the control line comprises a line induced structure within a second portion of the image data or within a second portion of the test area, wherein the first portion and the second portion of the image data or of the test area of the image data separate along a line parallel to the direction of the control line, and the first portion of the image data comprises the control line. It goes without saying that the limiting of the testing to a certain area, e.g., a second portion of the image data, may help to increase reliability by decreasing the risk of false positive results only if the position of the test line is precisely known so that the testing may be restricted to a region that includes the test line secured. If the position is not precisely known it may not be secured that the test region includes the test line position which significantly increases the risk of false negative results be increased.

In step f, the result of the lateral flow test, i.e., whether a test line has formed indicating the presence of the analyte in the sample or not, is provided, e.g., outputted or communicated to the user and/or others such as a healthcare professional and/or a caregiver. The providing may be done visually, acoustically and/or in a tactile form, for example, by displaying the result or a corresponding message on a display of the mobile device, or by an acoustic or tactile signal, such as a read out result or message and/or a vibration of the mobile device. Alternatively or additionally providing may be implemented by sending the result or a corresponding message via a wired or wireless connection to another computing device or wireless to a cloud server or the like.

The method steps may be performed in the described order and all steps may be computer-implemented, in particular using a processing unit. The steps may be performed all or in parts be performed on a mobile device and/or a server, specifically a cloud server. In particular, all steps may be executed on the same mobile device, e.g., a mobile phone, that may also be used to generate the image data of the lateral flow test. Alternatively, for example, all steps may be performed on a server, e.g., a cloud server, wherein step a may comprise receiving the image data from a mobile device and step f may comprise providing the result to the same mobile device and/or to another mobile device. In an alternative embodiment, steps a and f may be executed on a mobile device such as a mobile phone while all or some of the further steps a.1 to e may be performed on a server, such as a cloud server. It is understood that if some of the steps are executed on different processing devices, said processing device are communicating the necessary and/or generated data via a wired connection or wirelessly, for example, step a is performed on a mobile device, then the received image data is transmitted to a server or another computing device on which the following steps b to d are performed. The result may then be transmitted back to the mobile device to perform step f.

If feasible, the method may comprise further steps that are performed before step a, after step f or in between steps. Such further steps may comprise further image processing such as smoothing the image data.

Due to relying the control line and the corresponding adaption of the parameters of the direction selective filter the inventive method may waive any requirements with regard to the orientation of the lateral flow test within the image data or any additional features such as position markers within the image data and furthermore exhibits a very high sensitivity as well as a very low rate of false positive detection. Thus, an advantage of the method is that it provides an automated, very reliable results for a lateral flow test in a cost-efficient, easy-to-implement way using a mobile device for image data generation that does not rely on the abilities of a user or at least not too much. Another advantage is that the evaluation is performed fully automated, i.e., computer-implemented, without the need for a special read-out device and without a high demand with regard to the processing power of the computing device, e.g., the mobile device, that runs the method steps. In particular, all method steps may be performed by a mobile device, such a mobile phone, e.g., the mobile phone used to generate the image data of the lateral flow test. It goes without saying that individual method steps could also be carried out on other computing devices, e.g., a server, a personal computer or the like.

Without excluding further possible embodiment, the following further embodiment may be envisaged:

A method for evaluating a lateral flow test using a mobile device having at least one camera:
a. receiving, by a processor of the mobile device, an image data of a test area of a lateral flow test, wherein the image data is generated with the camera of the mobile device,
b. determining, by the processor of the mobile device or by another processor, at least a direction and a width of a control line within the test area of the image data,
c. generating, by the processor of the mobile device or by another processor, a direction selective filter based on the direction and width of the control line determined in step b,
d. filtering, by the processor of the mobile device or by another processor, the image data with the generated direction selective filter,
e. evaluating, by the processor of the mobile device or by another processor, the filtered image data of step d with regard to a presence or an absence of a test line, and
f. providing, by the mobile device, a result of the lateral flow test based on the evaluation of step e.

In an alternative embodiment, all steps are performed by a processor of server, such as a cloud server, or another computing device.

In a first embodiment, the direction selective filter is a Gabor kernel function.

In a further embodiment, the image data received in step a is converted, by a processor, into a predetermined color space before step b.

In another embodiment, after step a and before step b, the image data is smoothed by using, by the processor, a filter such as a Savitzky-Golay filter.

Additionally, in an embodiment, after step a and before step b, a position of the test area in the image data is determined, by the processor, and the image data is reduced, by the processor, to only comprise the test area.

In a further embodiment, step b comprises using, by the processor, an edge detection function.

Additionally, in an embodiment, step b comprises calculating, by the processor, a magnitude and orientation of an image data gradient for each pixel of the image data, and determining, by the processor, clusters of pixels with similar orientation.

In another embodiment, step e comprises determining, by the processor, if the filtered image data in a direction perpendicular to the direction of the control line comprises only one line induced structure or at least two line induced structures, a line induced structure, for example, being a maximum, a minimum, or a pair of a maximum and a minimum.

Additionally, in an embodiment, step e comprises determining, by the processor, if the filtered image data in a direction perpendicular to the direction of the control line comprises a maximum in a second portion of the image data and/or in a second portion of the test area, wherein a first portion and the second portion of the image data and/or the test area separate along a line parallel to the direction of the control line, and the first portion of the image data and/or test area comprises the control line.

In another embodiment, an analytical system is provided, the system comprising at least one mobile device having at least one camera, at least one lateral flow test, and at least one processor configured to perform the method described before.

### BRIEF DESCRIPTION OF THE DRAWINGS

Further optional features and embodiments will be disclosed in more detail in the subsequent description of embodiments. Therein, the respective optional features may be realized in an isolated fashion as well as in any arbitrary feasible combination, as the skilled person will realize. The scope of this disclosure is not restricted by the preferred embodiments. The embodiments are schematically depicted in the figures.

To easily identify the discussion of any particular element or act, the most significant digit or digits in a reference number refer to the figure number in which that element is first introduced.

The above-mentioned aspects of exemplary embodiments will become more apparent and will be better understood by reference to the following description of the embodiments taken in conjunction with the accompanying drawings, wherein:

FIG. 1 illustrates an exemplary setup for automatically determining a lateral flow test; and

FIG. 2 illustrates an aspect of the subject method in accordance with one embodiment.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

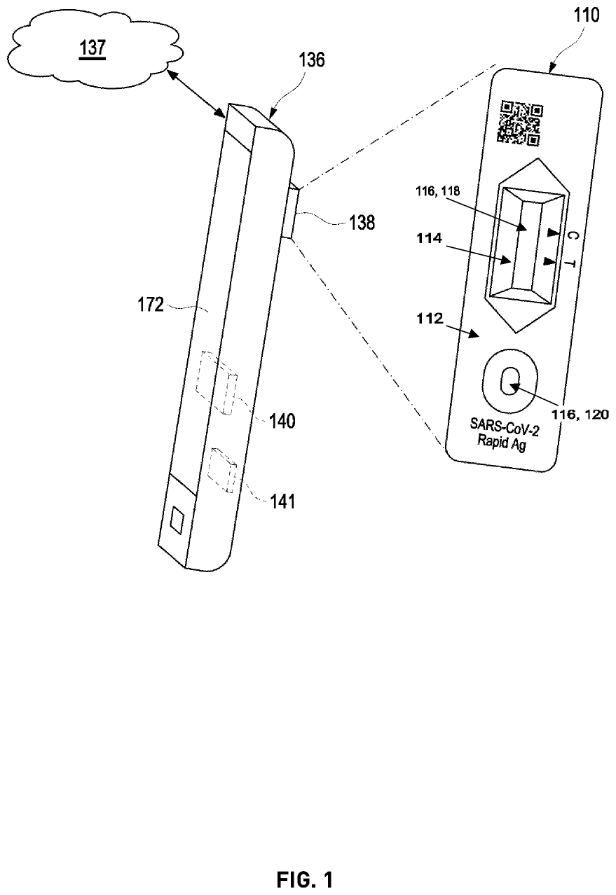

FIG. 1 shows an exemplary lateral flow test 110 for performing lateral flow Covid-19 tests, which may be a typical use case of this disclosure, particularly referring to computer-implemented steps for evaluating such a lateral flow test 110 based on image data generated by a mobile device 136. The lateral flow test 110 may comprise a housing 112 which may further comprise at least one window 114 through which at least optical access to a substrate 116 may be possible. The substrate 116 may comprise a test area 118 and/or an application site 120, wherein the test area 118 is configured to perform at least one optically detectable reaction in the presence of at least one target substance, e.g., a specific analyte.

As may be derived from FIG. 1, in an exemplary mobile device 136, particularly used for detecting the at least one analyte in the sample of the bodily fluid, the mobile device 136 has at least one camera 138. The mobile device 136 may further have at least one processor 140. The mobile device 136 may comprise a storage device 141 and/or a display 172. The mobile device 136 is configured, specifically by software configuration, for performing at least one computer-implemented method for evaluating a lateral flow test to detect at least one analyte in a sample of a bodily fluid applied to the application site 120 of the lateral flow test 110 as described in the following. Particularly for configuring the mobile device 136 by software configuration, a computer program, comprising instructions which, when the program is executed by the mobile device 136, cause the mobile device 136 to perform the computer-implemented method for evaluating the lateral flow test 110. Particularly the computer program may be stored on a computer-readable storage medium. The computer-readable storage medium, specifically a non-transient computer-readable storage medium, may comprise instructions which, when the instructions are executed by the mobile device 136, cause the mobile device 136 to perform the computer-implemented method of evaluating the lateral flow test 110.

Optionally, the mobile device 136 may transfer data to and/or receive data from a server 137, particularly by using a connection interface of the mobile device 136.

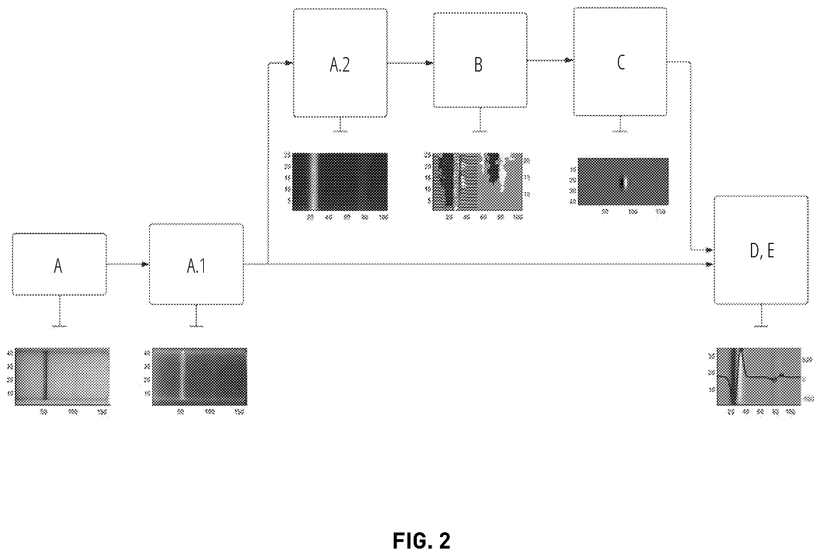

In FIG. 2, an exemplary computer-implemented method of evaluating a lateral flow test is illustrated. The method comprises the following steps:

In a step a, an image data covering at least the test area 118 of the lateral flow test 110 captured by the camera 138 of the mobile device 136 is received. For example, the image data is received by the processor 140 of the mobile device 136 or by any other processing device, wherein the transfer of the image data may be performed via a wired or wireless connection. The image data may be stored in the storage device 141 and/or in any other data storage device.

In a step a.1, the received image data is converted to a predetermined color space. For example, the processor 140 of the mobile device 136 converts the image data into a monochromatic color-space or, as in the shown embodiment, into the L* channel of the L*a*b* color space, wherein the L* channel represents the perceptual lightness.

In an optional step a.2, the converted image data is smoothed by using a smoothing filter such as, for example, a Savitzky-Golay filter to correct uneven illumination or artifacts.

In step b, the converted image data is used to determine a direction and a width of a control line within the test area of the image data. In the shown embodiment for each pixel of the converted image data a magnitude and direction of a gradient is determined and clusters of similar gradient orientation, i.e., direction, are identified. If the gradient magnitudes of the pixels contained in an identified cluster are above a threshold and the gradient vectors are within an accepted range, the cluster is kept. All kept clusters may then be included in a newly created image, wherein the pixels of each cluster are given a value of −1 or 1 depending on its orientation resulting in the depicted image regarding step b.

In particular, a cluster corresponding to the control line is identified. The width of the control line may, for example, be determined based on a distance between a cluster of maximal gradient values and a cluster of minimal gradient values corresponding to the control line structure while the direction of the control line may, for example, be determined based on the orientation of the cluster of maximal gradient values and/or the cluster of minimal gradient values.

In step c, a direction selective filter such as a Gabor kernel function is generated based on the width and direction of the control line determined in step b. In case of a Gabor kernel function, in particular, the wavelength λ of the Gabor kernel function is adapted to the determined width while the orientation θ is adapted to the determined direction.

In step d, the direction selective filter, e.g., the Gabor kernel function, generated in step c is applied to the converted image data, i.e., the image data as resulting from step a.1. In another embodiment, the direction selective filter is applied to the originally received image data of step a, or to the smoothed image data resulting from step a.2 or to any of the previous image data further processed by any appropriate filter/function/algorithm to further enhance the structures of interest or reduce noise or other undesirable features.

The resulting image data, for example, an imaginary impulse response of a Gabor kernel function, is used in step e to determine whether the lateral flow test 110 is positive, or, in other words, if a test line has formed or not. In the image data filtered by the direction selective filter any structure with characteristics corresponding to the control line will result in an additional typical line-induced structure such as, for example, an additional minima-maxima-sequence while other structures with differing characteristics, e.g., differing orientation or width, will be suppressed.

The result found in step d and e is communicated in step f, for example, via a corresponding message text or image or the like displayed on the display 172 of the mobile device 136. The communication may alternatively or additionally be implemented by sending the corresponding message text or image via a wired or wireless connection to another computer or mobile device or wearable electronics device or the like. The communication may alternatively or additionally be implemented in a non-visual way, e.g., via an acoustic signal or via a tactile signal, e.g., a vibration.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A method for evaluating a lateral flow test:
(a) receiving an image data of a test area of the lateral flow test, wherein the image data is generated with a mobile device comprising a camera,
(b) determining at least a direction and a width of a control line within the test area of the image data of step (a),
(c) generating a direction selective filter based on the direction and the width of the control line determined in step (b), wherein the direction selective filter is a digital filter to enhance and/or suppress features based on the orientation of the features,
(d) filtering the image data of step (a) with the generated direction selective filter,
(e) evaluating the filtered image data of step (d) to determine if a test line is present or absent, and
(f) providing a result of the lateral flow test based on the evaluation of step (e).

2. The method of claim 1, wherein the direction selective filter is a Gabor kernel function.

3. The method of claim 1, wherein in a step (a.1), the image data received in step (a) is converted into a predetermined color space before step (b).

4. The method of claim 3, wherein in step (d) the image data of step (a.1) is filtered.

5. The method of claim 1, wherein in a step (a.2) after step (a) and before step (b), the image data is smoothed by using a smoothing filter.

6. The method of claim 5, wherein in step (d) the image data of step (a.2) is filtered.

7. The method of claim 1, wherein after step (a), a position of the test area in the image data is determined and the image data is reduced to only comprise the test area.

8. The method of claim 1, wherein step (b) comprises using an edge detection function.

9. The method of claim 8, wherein step (b) comprises:
calculating a magnitude and orientation of an image data gradient for each pixel of the image data; and
determining clusters of pixels with similar orientation.

10. The method of claim 1, wherein step (e) comprises determining if the filtered image data in a direction perpendicular to the direction of the control line comprises only one line induced structure or at least two line induced structures.

11. The method of claim 10, wherein step (e) comprises determining if the filtered image data in a direction perpendicular to the direction of the control line comprises a line induced structure in a second portion of the image data and/or in a second portion of the test area, wherein
the first portion and the second portion of the image data and/or the test area separate along a line parallel to the direction of the control line, and
the first portion of the image data and/or test area comprises the control line.

12. The method of claim 1, wherein in a step (a.2) after step (a) and before step (b), the image data is smoothed by using a Savitzky-Golay filter.

13. A non-transitory computer-readable storage medium including instructions that, when processed by a computing device comprising a processor, configure the computing device to perform the method of claim 1.

14. A data processing device comprising means for carrying out steps (a) to (f) of the method of claim 1 for evaluating a lateral flow test.

15. A mobile device having at least one camera and at least one processor, the mobile device being configured for performing the method for evaluating a lateral flow test according to claim 1.
